(19) United States
(12) Patent Application Publication
(10) Pub. No.: US 2025/0054178 A1
(43) Pub. Date: Feb. 13, 2025

(54) VEHICLE CONTROL SYSTEM AND VEHICLE CONTROL METHOD

(71) Applicant: TOYOTA JIDOSHA KABUSHIKI KAISHA, Toyota-shi (JP)

(72) Inventors: Hiroya CHIBA, Fuji-shi (JP); Daisuke KAKUMA, Susono-shi (JP); Kento IWAHORI, Nagoya-shi (JP)

(73) Assignee: TOYOTA JIDOSHA KABUSHIKI KAISHA, Toyota-shi (JP)

(21) Appl. No.: 18/752,456

(22) Filed: Jun. 24, 2024

(30) Foreign Application Priority Data
Aug. 7, 2023 (JP) 2023-128512

(51) Int. Cl. G06T 7/70; G05D 1/249; G06V 20/52

(52) U.S. Cl. CPC G06T 7/70; G05D 1/249; G06V 20/52; G06T 2207/30261

(57) ABSTRACT

The present disclosure provides a vehicle control system for controlling a vehicle. The vehicle control system comprises processing circuitry. The processing circuitry is configured to acquire a video captured by a common camera, calculate a first vehicle position that is a position of the vehicle from the video based on a first position estimation algorithm, calculate a second vehicle position that is a position of the vehicle from the video based on a second position estimation algorithm, and decelerate or stop the vehicle according to a deviation state in which a position difference between the first vehicle position and the second vehicle position exceeds an allowable error.

### CROSS-REFERENCE TO RELATED APPLICATION

The present application claims priority under 35 U.S.C. § 119 to Japanese Patent Application No. 2023-128512, filed on Aug. 7, 2023, the contents of which application are incorporated herein by reference in their entirety.

### FIELD

The present disclosure relates to a technique for controlling a vehicle using a camera.

JP2021-081961A discloses a system for controlling travel of a vehicle in a predetermined area. A control device in this system includes a first acquisition unit, which acquires detection data of a vehicle in a predetermined area from a detection unit provided in the predetermined area, a first estimation unit, which estimates a first position indicating a position of the vehicle based on the detection data, a second acquisition unit, which acquires a second position indicating a position of the vehicle estimated by a second estimation unit provided in the vehicle, and a calibration control unit, which makes one of the first estimation unit and the second estimation unit to execute calibration based on a comparison result between the first position and the second position.

As documents showing the technical level of the technical field related to the present disclosure, WO 2019/073795, JP2019-135620A, JPH11-039589A, JPH11-096494A, JP2019-020786A, and JP2019-130997A can be exemplified in addition to the above-described JP2021-081961A.

### SUMMARY

Various algorithms may be proposed as an algorithm for estimating a vehicle position based on a video (image) captured by a camera. However, a technique for estimating a vehicle position from a common video captured by a common camera based on a plurality of different algorithms has not been sufficiently examined.

The present disclosure provides a vehicle control system for controlling a vehicle. The vehicle control system comprises processing circuitry. The processing circuitry is configured to acquire a video captured by a common camera, calculate a first vehicle position that is a position of the vehicle from the video based on a first position estimation algorithm, calculate a second vehicle position that is a position of the vehicle from the video based on a second position estimation algorithm, and decelerate or stop the vehicle according to a deviation state in which a position difference between the first vehicle position and the second vehicle position exceeds an allowable error.

The present disclosure provides a vehicle control method for controlling a vehicle. The vehicle control method includes acquiring a video captured by a common camera, calculating a first vehicle position that is a position of the vehicle from the video based on a first position estimation algorithm, calculating a second vehicle position that is a position of the vehicle from the video based on a second position estimation algorithm, and decelerating or stopping the vehicle according to a deviation state in which a position difference between the first vehicle position and the second vehicle position exceeds an allowable error.

According to the technique of the present disclosure, a plurality of vehicle positions is calculated from a common video based on a plurality of position estimation algorithms. By comparing a plurality of vehicle positions calculated, reliability of the position estimation can be evaluated. When reliability of the position estimation is considered to be reduced, the vehicle is decelerated or stopped. Thus, safety of the vehicle can be secured.

### BRIEF DESCRIPTION OF THE DRAWINGS

FIG. 1 is a diagram for explaining an overview of a vehicle control system according to a first embodiment.

FIG. 2 is a diagram for explaining a position difference calculated by the vehicle control system.

FIG. 3 is a block diagram showing an example of processing units included in the vehicle control system.

FIG. 4 is a diagram showing an example of an environment parameter in a third embodiment.

FIG. 5 is a graph showing an example of a relationship between the environment parameter and an allowable error.

FIG. 6 is a diagram for explaining a fourth embodiment.

FIG. 7 is a graph showing an example of the allowable error in the fourth embodiment.

FIG. 8 is a diagram for explaining a fifth embodiment.

FIG. 9 is another diagram for explaining the fifth embodiment.

FIG. 10 is a diagram showing a configuration example of a vehicle according to a sixth embodiment.

### DETAILED DESCRIPTION

Embodiments of the present disclosure will be described with reference to the accompanying drawings.

### 1. First Embodiment

### 1-1. Overview and Basic Configuration of Vehicle Control System

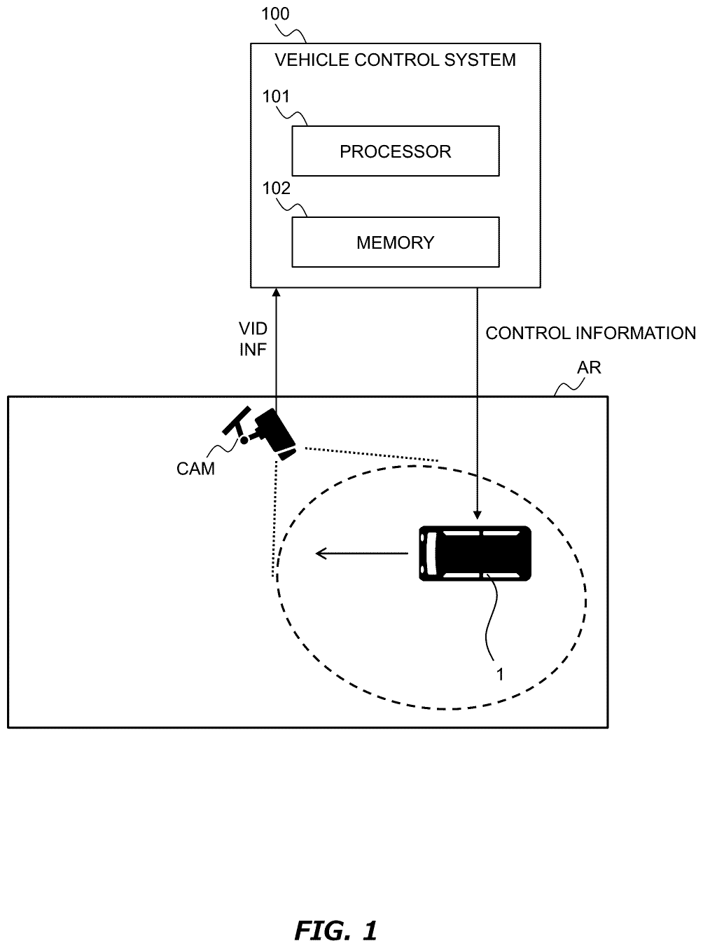

FIG. 1 is a schematic diagram for explaining an overview of a vehicle control system 100 according to a present embodiment. The vehicle control system 100 controls a vehicle 1 in a predetermined area AR. The vehicle 1 may be an autonomous driving vehicle which can perform autonomous driving at least in the predetermined area AR. The vehicle 1 to be controlled by the vehicle control system 100 may be plural. At least a part of the vehicle control system 100 may be included in a management server outside the vehicle 1. At least a part of the vehicle control system 100 may be included in an in-vehicle system mounted on the vehicle 1. The vehicle control system 100 may be distributed to the management server and the in-vehicle system.

At least one camera CAM is installed in the predetermined area AR. The camera CAM is an infrastructure camera capable of capturing an image of the inside of the predetermined area AR. The camera CAM captures an image of a situation in the predetermined area AR and acquires a video VID indicating the situation in the predetermined area AR. The video VID is a set of images obtained by the camera CAM continuously capturing images in the angle of view at predetermined capturing cycles. The vehicle 1 traveling in the predetermined area AR may be shown in the video VID. Examples of the predetermined area AR in which the camera CAM is installed include a parking lot, a factory, a roadway (an ordinary road, a highway), and the like. In a case where the predetermined area AR is a parking lot, the vehicle 1 may be able to handle automated valet parking (AVP). In a case where the predetermined area AR is a factory site, the vehicle 1 may be assembled in an assembly factory and automatically travel from the assembly factory to a yard. In this case, one or more cameras CAM are installed on the road from the assembly factory to the yard.

The vehicle control system 100 includes one or more processors 101 (hereinafter, simply referred to as a processor 101 or processing circuitry) and one or more memories 102 (hereinafter, simply referred to as a memory 102). The processor 101 executes various processes. Examples of the processor 101 include a central processing unit (CPU), a graphics processing unit (GPU), an application specific integrated circuit (ASIC), and a field-programmable gate array (FPGA). The memory 102 stores one or more programs and various kinds of information. Examples of the memory 102 include a hard disk drive (HDD), a solid state drive (SSD), a volatile memory, and a nonvolatile memory. The functions of the vehicle control system 100 may be realized by cooperation of the processor 101 executing one or more programs and the memory 102. The one or more programs may be recorded in a computer-readable storage medium.

The vehicle control system 100 is communicably connected to the camera CAM. The video VID captured by the camera CAM is transmitted to the vehicle control system 100 via a wired communication network or a wireless communication network. The vehicle control system 100 acquires the video VID captured by the camera CAM. The vehicle control system 100 estimates a position of the vehicle 1 (hereinafter referred to as a vehicle position PV) in the predetermined area AR based on the video VID. More specifically, the vehicle control system 100 estimates (calculates) the vehicle position PV from the video VID based on a predetermined position estimation algorithm.

For example, the vehicle control system 100 detects (recognizes) the vehicle 1 in the predetermined area AR from the video VID based on the predetermined vehicle detection algorithm. For example, the vehicle control system 100 recognizes the vehicle 1 included in the video VID by using image recognition AI. The image recognition AI is generated in advance through machine learning. Then, the vehicle control system 100 calculates the position of the vehicle 1 in the video VID (in the image). In other words, the vehicle control system 100 calculates a relative position of the vehicle 1 as viewed from the camera CAM. On the other hand, the vehicle control system 100 has camera information INF. The camera information INF is information indicating an installation position, an installation direction, the angle of view, and the like of the camera CAM. The camera information INF is provided to the vehicle control system 100 in advance and stored in the memory 102. The camera information INF may be transmitted from the camera CAM. The vehicle control system 100 can calculate the vehicle position PV based on the relative position of the vehicle 1 in the image and the camera information INF.

The vehicle control system 100 controls the vehicle 1 based on the vehicle position PV estimated in this way. For example, the vehicle control system 100 performs autonomous driving control based on the vehicle position PV. As another example, the vehicle control system 100 may perform driving support control based on the vehicle position PV. Examples of the driving support control include risk avoidance control, lane keeping control, and the like. For example, the vehicle control system 100 generates a target trajectory of the vehicle 1. The target trajectory includes a target position and a target speed of the vehicle 1. Then, the vehicle control system 100 controls traveling of the vehicle 1 so as to follow the target trajectory.

The vehicle 1 includes a travel device. The travel device includes a driving device, which drives the vehicle 1, a braking device, which brakes the vehicle 1, and a steering device, which steers the vehicle 1. Control information is information for controlling the vehicle 1. The vehicle control system 100 controls the vehicle 1 by controlling the travel device in accordance with the control information.

In this way, the vehicle 1 is controlled based on the vehicle position PV, which is estimated based on the predetermined position estimation algorithm. However, depending on a distance between the vehicle 1 and the camera CAM and environment around the vehicle 1, estimation accuracy of the vehicle position PV, that is, reliability of the estimated vehicle position PV may be reduced. For example, in a case where the distance between the vehicle 1 and the camera CAM is long, the reliability of the vehicle position PV may be reduced. Further, when the video VID captured in backlight environment is used, the reliability of the vehicle position PV may be reduced. If the reliability of the vehicle position PV is reduced, accuracy of the vehicle control based on the vehicle position PV may also be reduced. This is not desirable from the viewpoint of safety.

Therefore, according to the present embodiment, the reliability of the vehicle position PV is evaluated. More specifically, the vehicle control system 100 calculates a plurality of vehicle positions PV based on a plurality of different position estimation algorithms, respectively. For example, a plurality of position estimation algorithms is generated and provided by different developers. In the case where the position estimation algorithm uses the image recognition AI, learning levels of the respective image recognition AI may be different. Although a plurality of different position estimation algorithms is used, the input video VID is a common video VID captured by a common camera CAM. That is, the vehicle control system 100 calculates a plurality of vehicle positions PV from the common video VID based on a plurality of different position estimation algorithms. Further, the vehicle control system 100 compares a plurality of vehicle positions PV with each other. If the difference between a plurality of vehicle positions PV is within an allowable range, it can be said that the reliability of a plurality of vehicle positions PV (that is, the reliability of a plurality of position estimation algorithms) is high.

On the other hand, if the difference among a plurality of vehicle positions PV exceeds the allowable range, it is considered that the reliability of at least one of the vehicle positions PV (that is, reliability of at least one of the position estimation algorithms) is reduced. In other words, it is considered that a situation in which the reliability of the position estimation is reduced occurs. In this case, the vehicle control system 100 decelerates or stops the vehicle 1. Thus, the safety of traveling of the vehicle can be ensured.

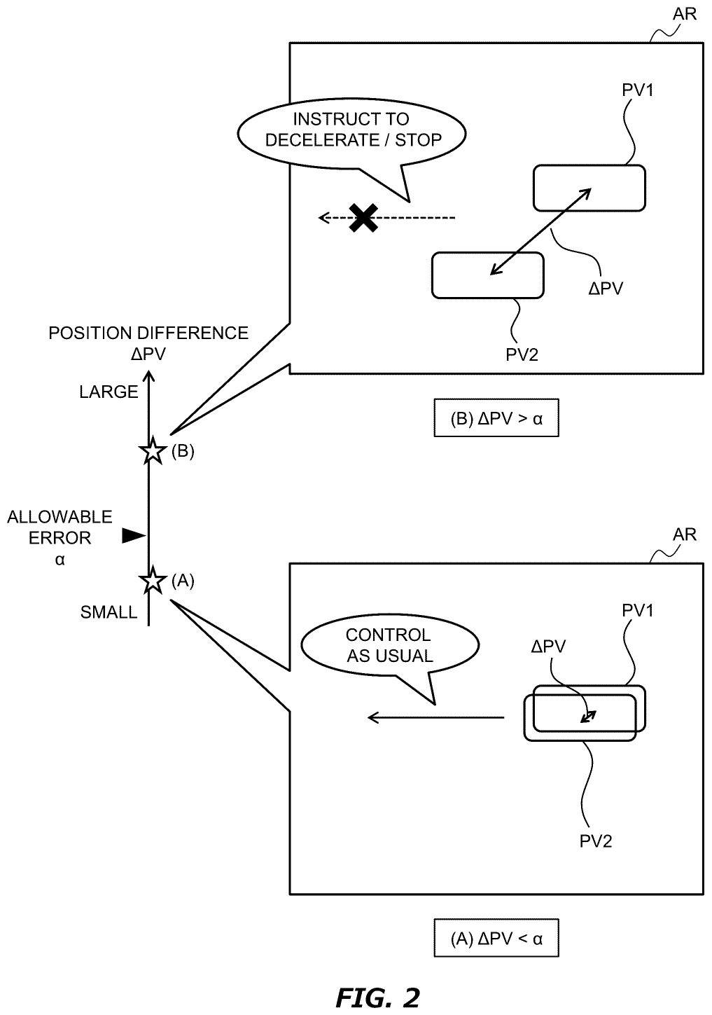

FIG. 2 is a diagram for explaining processing according to the present embodiment. In the following, a case where two types of position estimation algorithms are used is described. It is the same as a case where three or more types of position estimation algorithms are used.

The vehicle control system 100 calculates a first vehicle position PV1 from the common image VID based on a first position estimation algorithm. Further, the vehicle control system 100 calculates a second vehicle position PV2 from the common image VID based on a second position estimation algorithm. The vehicle control system 100 compares the first vehicle position PV1 and the second vehicle position PV2 and calculates a position difference ΔPV between the two vehicle positions. The position difference ΔPV is calculated as, for example, a difference between the center of the first vehicle position PV1 and the center of the second vehicle position PV2. Then, when the position difference ΔPV is larger than an allowable error α, that is, when the difference between the two vehicle positions is larger than a range allowed as an error, the vehicle control system 100 decelerates or stops the vehicle 1.

FIG. 2 shows two situations, a situation A and a situation B. The situation A is a situation in which the position difference ΔPV is smaller than the allowable error α. When the position difference ΔPV between the two vehicle positions is smaller than the allowable error α, it is considered that the reliability of the position estimation is ensured. Thus, the vehicle control system 100 controls the vehicle 1 as usual.

In contrast, the situation B is a situation in which the position difference ΔPV is greater than the allowable error α. When the position difference ΔPV is larger than the allowable error α, the reliability of the position estimation may be reduced. Thus, the vehicle control system 100 decelerates or stops the vehicle 1.

As described above, according to the vehicle control system 100 of the present embodiment, two types of vehicle positions are calculated from the video acquired from the common camera CAM based on two types of algorithms, and the reliability of the position estimation can be estimated by comparing the two types of vehicle positions. Then, in a situation where the reliability of the position estimation may be reduced, the vehicle 1 is decelerated or stopped, and thus it is possible to ensure safety of traveling of the vehicle 1.

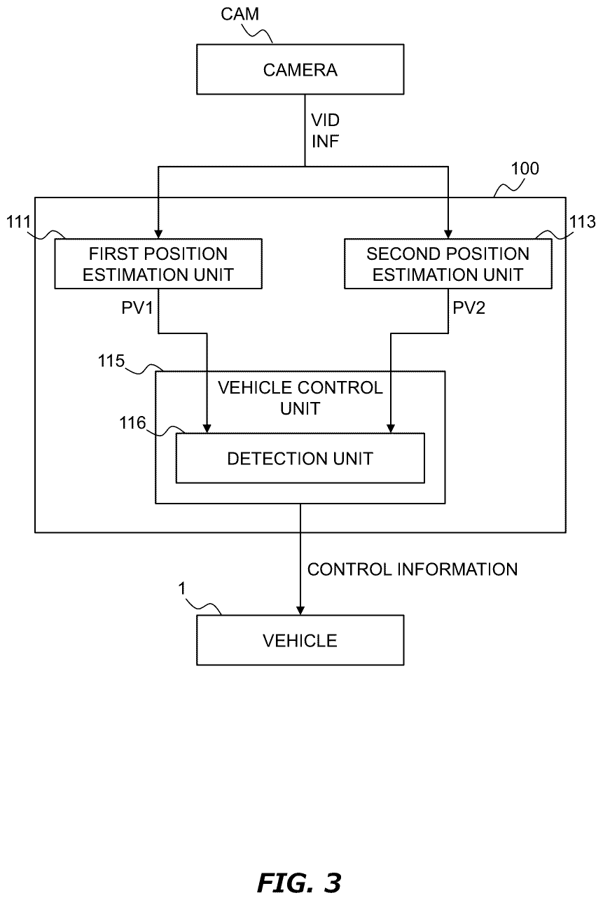

FIG. 3 is a block diagram showing an example of processing units included in the vehicle control system 100. The vehicle control system 100 includes a first position estimation unit 111, a second position estimation unit 113, and a vehicle control unit 115. The vehicle control unit 115 includes a detection unit 116. These processing units are realized by the processor 101 executing the program stored in the memory 102.

The first position estimation unit 111 and the second position estimation unit 113 are processing units for estimating the position of the vehicle 1 in the predetermined area AR based on the video VID acquired from the camera CAM and the camera information INF. The processor 101 and the memory 102 constituting the first position estimation unit 111 and the second position estimation unit 113 may be common or may be different. Algorithms for position estimation are applied to the first position estimation unit 111 and the second position estimation unit 113. The position estimation of the vehicle 1 based on the video VID and the camera information INF is performed in accordance with each algorithm.

When performing the position estimation, the first position estimation unit 111 and the second position estimation unit 113 acquire the common video VID from the common camera CAM. In a case where there is a plurality of cameras CAM, these two units acquire the video VID from the same one camera CAM among a plurality of cameras CAM. However, the first position estimation unit 111 and the second position estimation unit 113 are different in the algorithm to be applied. A first position estimation algorithm is applied to the first position estimation unit 111, and a second position estimation algorithm, which is different from the first position estimation algorithm, is applied to the second position estimation unit 113.

The algorithm applied to one or both of the first position estimation unit 111 and the second position estimation unit 113 may be a machine learning model. In a case where the machine learning model is applied to both of the first position estimation unit 111 and the second position estimation unit 113, the machine learning models applied to the first position estimation unit 111 and the second position estimation unit 113 may be machine learning models having different learning levels. The first position estimation unit 111 calculates the first vehicle position PV1 from the video VID based on the first position estimation algorithm. The second position estimation unit 113 calculates the second vehicle position PV2 from the video VID based on the second position estimation algorithm.

The first vehicle position PV1 and the second vehicle position PV2 are input to the detection unit 116. The detection unit 116 detects a state in which the first vehicle position PV 1 and the second vehicle position PV2 deviate from each other as a “deviation state”. More specifically, the detection unit 116 calculates the position difference ΔPV between the first vehicle position PV1 and the second vehicle position PV2 and detects a state where the position difference ΔPV exceeds the allowable error a as the deviation state. In the example of FIG. 2, the situation A is a situation in which the deviation state is not detected, and the situation B is a situation in which the deviation state is detected.

As described above, the video VID is a set of images continuously captured by the camera CAM, and the images captured by the camera CAM are sequentially input to the first position estimation unit 111 and the second position estimation unit 113. The first position estimation unit 111 and the second position estimation unit 113 sequentially perform the vehicle position estimation based on the sequentially input images. The first vehicle position PV1 and the second vehicle position PV2 calculated are sequentially input to the detection unit 116, and detection result by the detection unit 116 is also sequentially output each time the two vehicle positions are compared.

The vehicle control unit 115 controls the vehicle 1 based on the result of the position estimation by the first position estimation unit 111 and the second position estimation unit 113 and the detection result by the detection unit 116. It is arbitrary which of the first vehicle position PV1 and the second vehicle position PV2 is used as the result of the position estimation. Either one of them may be used, or the position of the vehicle 1 may be recalculated by the vehicle control unit 115 based on both of them.

At this time, if the deviation state is not detected, the vehicle control unit 115 controls the vehicle 1 as usual based on the estimated position of the vehicle 1. On the other hand, when the deviation state is detected, the vehicle control unit 115 decelerates or stops the vehicle 1 according to the deviation state.

### 1-2. Control of Vehicle in Response to Detection of Deviation State

The vehicle control unit 115 decelerates or stops the vehicle 1 according to the deviation state. Control of the vehicle 1 according to the deviation state may be to decelerate or stop the vehicle 1 immediately when the deviation state is detected. Alternatively, control of the vehicle 1 may be changed depending on a length of time during which the deviation state is detected. Four examples of the control of the vehicle 1 according to the deviation state are described below.

As the first example, when the deviation state is detected, the vehicle 1 may be decelerated or stopped regardless of the length of the detection time.

As the second example, the vehicle 1 may be decelerated or stopped when the deviation state is continuously detected for a predetermined period. That is, even when the deviation state is temporarily detected, the vehicle 1 may not be decelerated or stopped if the deviation state becomes not detected again before the predetermined time elapses. According to the second example, when the deviation state is detected due to a temporary factor such as erroneous detection, it is possible to prevent the vehicle 1 from being unnecessarily decelerated or stopped.

As the third example, the vehicle control unit 115 may start gentle deceleration of the vehicle 1 when the deviation state is detected. Then, when the detection of the deviation state continues for a predetermined period, the vehicle control unit 115 may further reduce the speed of the vehicle 1 and stop the vehicle 1. If the detection of the deviation state is resolved before the predetermined time elapses, the deceleration of the vehicle 1 is canceled, and the control of the vehicle 1 as usual is resumed.

According to the third example, since deceleration is started when the deviation state is detected, it is possible to ensure safety of the vehicle 1. On the other hand, if the detection of the deviation state is due to a temporary factor such as erroneous detection and is resolved in a short time, the deceleration is canceled, and thus it is possible to restrain the vehicle 1 from unnecessarily stopping.

As the fourth example, the vehicle control unit 115 may temporarily stop the vehicle 1 when the deviation state is detected. Then, if the detection of the deviation state continues for a predetermined period, the vehicle control unit 115 may perform a process for returning the vehicle 1 to a controllable state after shifting the vehicle 1 from the temporary stop state to a complete stop state. If the deviation state becomes not detected before the predetermined time elapses, the vehicle control unit 115 cancels stopping the vehicle 1 and restarts the control of the vehicle 1 performed before the temporary stop.

The process for returning the vehicle 1 to the controllable state may be, for example, notifying the administrator of the vehicle 1 that the reliability of the position estimation is reduced. Alternatively, in a case where the vehicle 1 is a remotely driven vehicle that can be controlled by remote driving, the vehicle 1 may be switched to the remote driving by requesting the remote driver to perform remote driving.

### 2. Second Embodiment (Stop of Vehicle in Response to Calculation Impossible State)

In the second embodiment, a calculation impossible state, in which either the first vehicle position PV1 or the second vehicle position PV2 cannot be calculated, is considered. In the calculation impossible state, since either the first vehicle position PV1 or the second vehicle position PV2 is not calculated, the detection unit 116 cannot calculate the position difference ΔPV and the deviation state is not detected. In such a state, the reliability of the position estimation cannot be evaluated.

Therefore, the vehicle control unit 115 decelerates or stops the vehicle 1 when the calculation impossible state is detected. At this time, the vehicle control unit 115 may first temporarily stop the vehicle 1 and may cancel stopping the vehicle 1 when the calculation impossible state is resolved before continuing for a predetermined period. In this case, when the calculation impossible state is continuously detected for the predetermined period, the vehicle 1 is shifted to the complete stop state.

By stopping the vehicle 1 when the calculation impossible state is detected, it is possible to perform control for ensuring safety even when the deviation state is not detected. Further, by canceling stopping the vehicle 1 when the calculation impossible state is resolved before continuing for a predetermined period, the control of the vehicle 1 can be returned to the normal control when the calculation impossible state is caused by a temporary factor such as temporary delay of a process. In this way, it is possible to prevent the traveling of the vehicle 1 from being excessively restrained.

### 3. Third Embodiment (Allowable Error Based on Environment Parameter)

The allowable error a set for the position difference ΔPV may be set in advance as a uniform value or may be set as a value that varies depending on a situation. In the third embodiment, the allowable error a is a variable value according to environment around the vehicle 1.

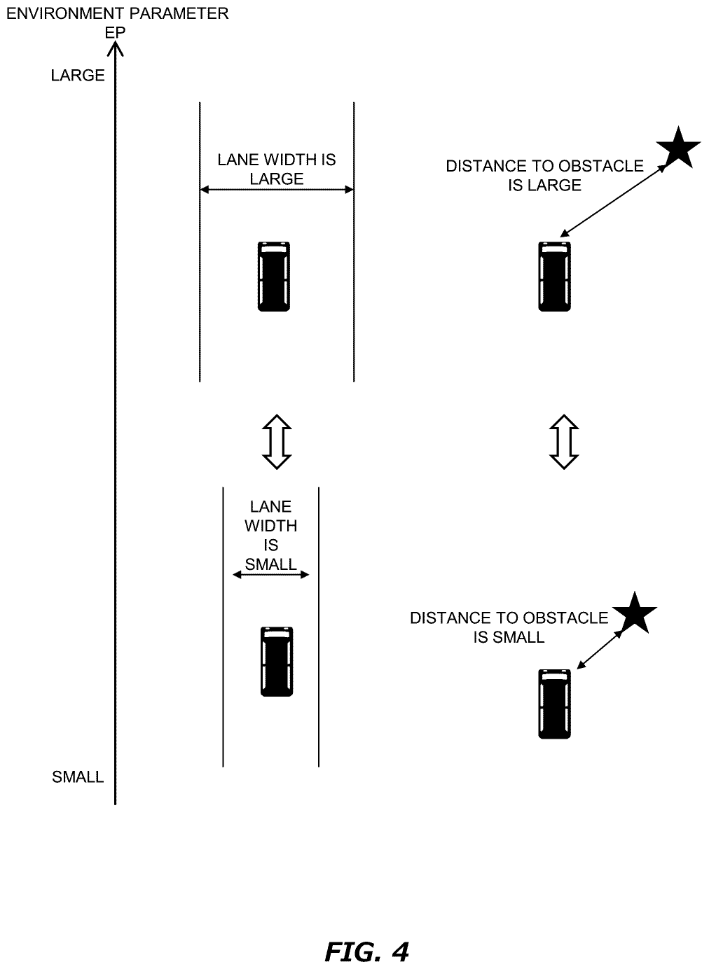

The detection unit 116 calculates an environment parameter EP and sets the allowable error a to a value that varies according to the environment parameter EP. FIG. 4 is a diagram for explaining an example of a method of calculating the environment parameter EP. The environment parameter EP is a parameter representing the environment around the vehicle 1 and is calculated to be larger as the vehicle 1 is in environment where the influence of the reliability of the position estimation is smaller. The environment in which the influence of the reliability of the position estimation is smaller is environment in which the influence on traveling of the vehicle 1 is considered to be smaller even when an error in control of the vehicle 1 occurs.

For example, the environment parameter EP may be set to increase as a lane width increases, based on the lane width of the lane in which the vehicle 1 travels. For example, the environment parameter EP may be a value representing the lane width itself. Even if an error occurs in the vehicle position PV, the possibility that the vehicle 1 deviates from the lane is small if the lane width is large, and it can be said that the influence on the traveling of the vehicle 1 is also small. Therefore, the environment parameter EP is increased as the lane width increases.

Alternatively, the environment parameter EP may be calculated based on the distance to an obstacle present around the vehicle 1 such that the environment parameter EP increases as the distance to the obstacle increases. For example, the distance itself to the obstacle may be used as the environment parameter EP. Even if an error occurs in the vehicle position PV, if the distance between the vehicle 1 and the obstacle is large, the possibility of collision of the vehicle 1 with the obstacle is small, and the influence on the traveling of the vehicle 1 is also small. Therefore, the environment parameter EP is increased as the distance to the obstacle increases.

The vehicle control system 100 can acquire information about the lane width and the distance to the obstacle by image analysis of the video VID acquired from the camera CAM. As another example, map information indicating the lane width may be stored in the memory 102 in advance, and the lane width at the position where the vehicle 1 travels may be acquired from the map information and the rough position of the vehicle 1. As still another example, the vehicle control system 100 may acquire these pieces of information from the vehicle 1. The vehicle 1 can acquire the lane width around the vehicle 1 and the distance to the obstacle from information obtained by an in-vehicle sensor such as a camera or a light detection and ranging (LIDAR) recognizing the surroundings of the vehicle 1.

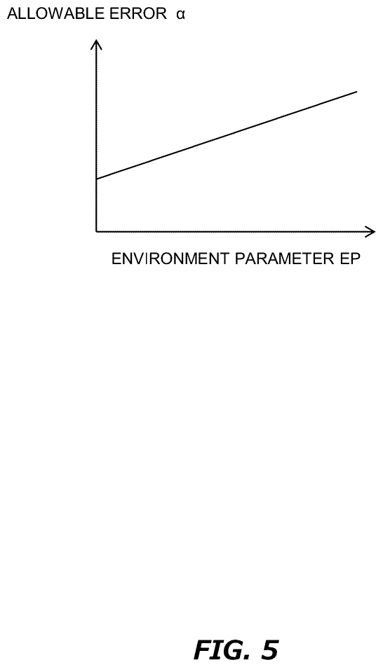

The allowable error α is set to increase as the environment parameter EP increases. FIG. 5 is a graph showing an example of the allowable error α which is set based on the environment parameter EP. The allowable error α may be set as a value that increases linearly in accordance with an increase in the environment parameter EP like this. Alternatively, the allowable error α may be set as a value that increases nonlinearly, for example, exponentially, in accordance with an increase in the environment parameter EP. The allowable error α may be increased monotonously or may be increased stepwise.

According to the third embodiment, the allowable error α is increased in environment in which the influence of the reliability of the position estimation is small. Increasing the allowable error α means that the deviation state is less likely to be detected. Therefore, it can be prevented that the vehicle 1 is unnecessarily decelerated or stopped even when the influence on the traveling of the vehicle 1 is small. In this way, it makes it easy to detect the deviation state in a scene in which the reliability of the position estimation has a large influence and it is possible to increase continuity of traveling of the vehicle 1 while maintaining the safety.

### 4. Fourth Embodiment (Allowable Error Based on Time Difference)

### 4-1. Method for Calculating Allowable Error

The fourth embodiment is also an embodiment in which the allowable error α is a variable value. As described above, the video VID is a set of images continuously acquired at capturing cycles. In the fourth embodiment, the allowable error α is variable in accordance with a time difference of the image used for the position estimation among the images included in the video VID.

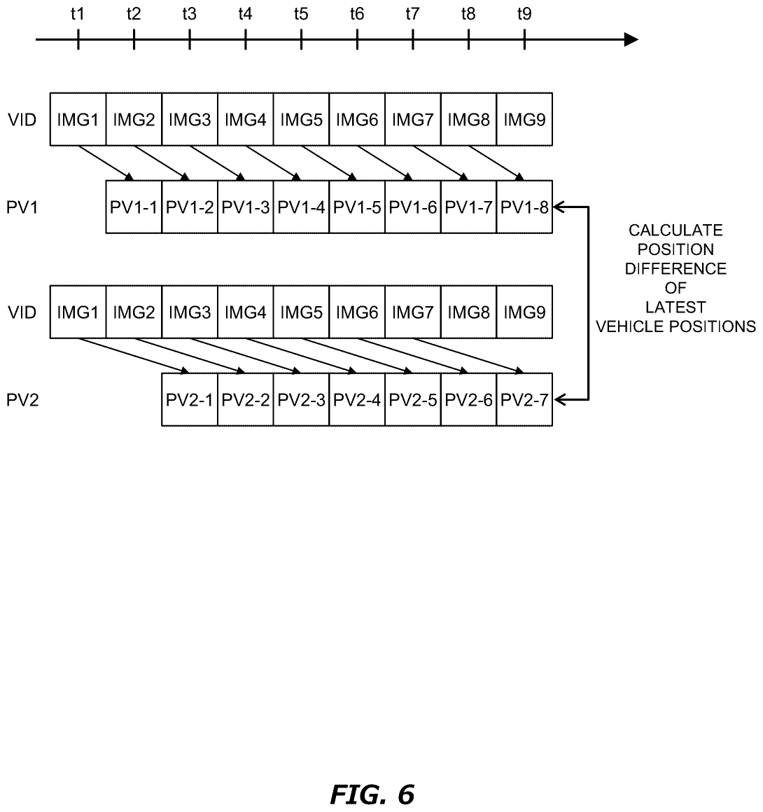

FIG. 6 is a diagram for explaining the fourth embodiment. The video VID captured by the camera CAM from the time t1 to the time t9 includes nine frame images IMG1-9.

The images IMG1 to IMG9 are sequentially input to the first position estimation unit 111 and the second position estimation unit 113, and the first vehicle position PV1 and the second vehicle position PV2 calculated based on the input images are sequentially output. However, although input is the same, the first vehicle position PV1 and the second vehicle position PV2 are not necessarily output at the same timing. Since different algorithms are applied to the first position estimation unit 111 and the second position estimation unit 113, calculation time for position estimation may be different. In addition, processing time such as communication time for transmitting images from the camera CAM to the respective processing units and communication time for transmitting position estimation results from the respective processing units to the detection unit 116 may be different. In the example of FIG. 6, processing time by the second position estimation unit 113 is longer than processing time by the first position estimation unit 111, and when the calculation results based on the images captured at the same timing are compared, the second vehicle position PV2 is output later than the first vehicle position PV1.

The detection unit 116 basically calculates the position difference ΔPV by comparing the latest vehicle positions. For example, it is assumed that the position difference ΔPV is calculated at the time t9. The latest first vehicle position PV1 is the first vehicle position PV1-8 calculated based on the image IMG8 captured at the time t8. The latest second vehicle position PV2 is the second vehicle position PV2-7 calculated based on the image IMG7 captured at the time t7. Therefore, the detection unit 116 calculates the position difference ΔPV by comparing the first vehicle position PV1-8 and the second vehicle position PV2-7.

However, since the time at which the image is captured is different, the actual position of the vehicle 1 may have changed between the image IMG7 and the image IMG8. If the actual positions of the vehicle 1 are different, the first vehicle position PV1 and the second vehicle position PV2 are inevitably different and the position difference ΔPV may become large. In this way, when the first vehicle position PV1 and the second vehicle position PV2 to be compared are calculated based on images captured at different time, the deviation state may be erroneously detected although the position estimation processes themselves are normally performed. However, it is not preferable that the vehicle 1 is decelerated or stopped even in such a case from the viewpoint of the continuity of traveling of the vehicle 1.

Therefore, in the fourth embodiment, the allowable error α is changed in consideration of the time difference between the time at which the images used for the calculation of the position estimation are captured. Hereinafter, among the images included in the video VID, the image used for calculating the first vehicle position PV1 is referred to as a first image, and the image used for calculating the second vehicle position PV2 is referred to as a second image. The detection unit 116 sets the allowable error α such that the allowable error α increases as the time difference between the time at which the first image is captured and the time at which the second image is captured increases.

For example, when the first vehicle position PV1-8 and the second vehicle position PV2-7 are compared to calculate the positional difference ΔPV, the first image is the image IMG8 and the second image is the image IMG7. Then, the detection unit 116 sets the allowable error α based on the time difference between the time t7 at which the image IMG7 is captured and the time t8 at which the image IMG8 is captured. In this case, the allowable error α is set to be larger than that in a case where the first image and the second image are the image captured at the same time.

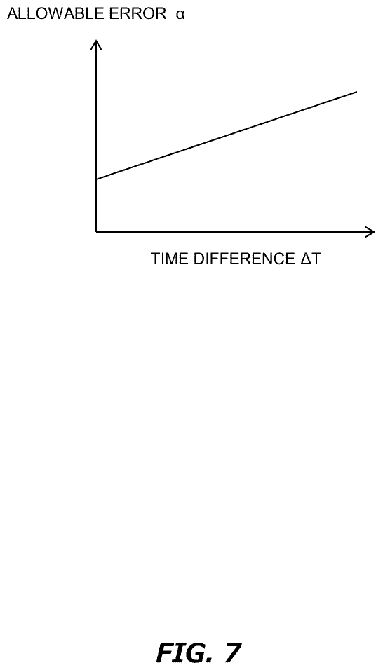

FIG. 7 shows an example of a method of setting the allowable error α based on the time difference ΔT between the time when the first image is captured and the time when the second image is captured. The allowable error α is set to increase as the time difference ΔT increases like this. The allowable error α may be set to increase monotonously or increase stepwise in accordance with increase in the time difference ΔT.

As described above, in the third embodiment, the time at which the images used for the calculation of the two types of vehicle positions are captured are compared, and the allowable error α is increased as the time difference ΔT of the captured time becomes larger. Increasing the allowable error α means that the deviation state becomes less likely to be detected. This can prevent erroneously detecting the deviation state even though the position estimation processes themselves are normally performed. As a result, it is possible to restrain the vehicle 1 from being unnecessarily decelerated or stopped, and to suppress the sense of discomfort of the occupant of the vehicle 1.

The detection unit 116 can determine the time difference between the capturing time of the first image and the capturing time of the second image as follows. Each image included in the video VID is associated with time information about the time at which the image is captured. The time information is a time stamp, a sequence number, or the like, and is stored in a frame header of each image. The first position estimation unit 111 and the second position estimation unit 113 transmit the time information of the image used to calculate the vehicle position to the detection unit 116 in association with the vehicle position. The detection unit 116 can calculate the time difference ΔT between the time at which the images used for the calculation of the vehicle position are captured, based on the time information of respective images associated with the first vehicle position PV1 and the second vehicle position PV2.

### 4-2. Application Example

The third embodiment can be further applied as follows. In the application example, the first vehicle position PV1 and the second vehicle position PV2 to be compared are not limited to the latest vehicle positions.

The calculated first vehicle position PV1 and the second vehicle position PV2 are not immediately compared with each other but are temporarily stored in a buffer. The buffer is a temporary storage area included in the memory 102. The detection unit 116 selects the vehicle positions where the time difference between the capturing time of the first image and the capturing time of the second image is less than an allowable time difference, among the first vehicle positions PV1 and the second vehicle positions PV2 stored in the buffer. The allowable time difference is set in advance as a time period in which a change in the position of the vehicle 1 is, if occurred, within an allowable range as an error. The detection unit 116 compares the first vehicle position PV1 and the second vehicle position PV2 acquired from the buffer and calculates the positional difference ΔPV.

### 5. Fifth Embodiment

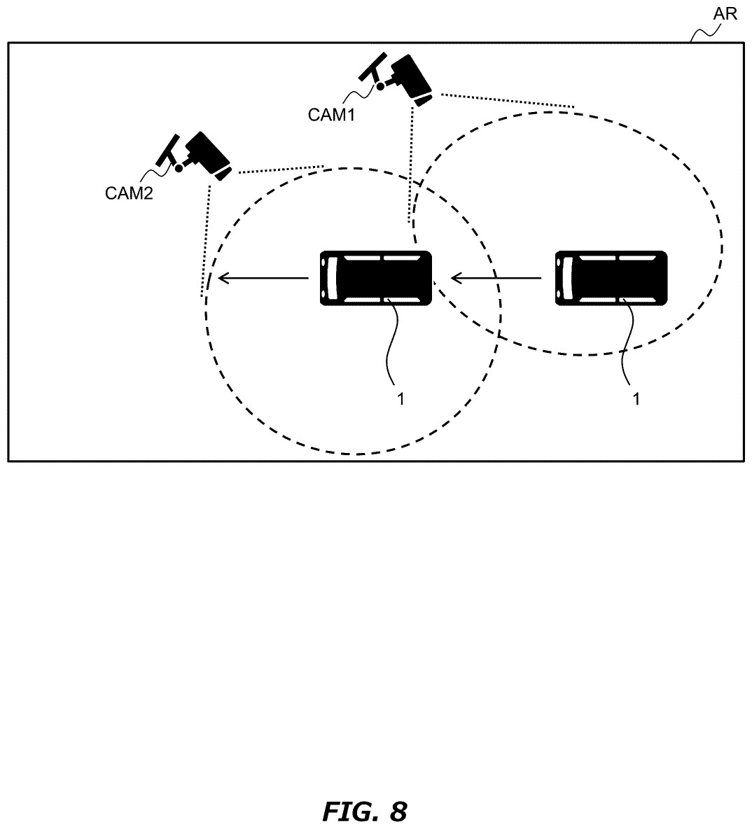

The fifth embodiment is an embodiment in a case where the camera CAM includes a plurality of infrastructure cameras and switching (handover) of the camera capturing the vehicle 1 is performed. FIG. 8 is a diagram for explaining the fifth embodiment. The camera CAM includes a camera CAM1 and a camera CAM2 as a plurality of infrastructure cameras. The camera CAM2 is installed at a position where the camera CAM2 captures the vehicle 1 after the camera CAM1. When the vehicle 1 deviates from the angle of view of the camera CAM1 in accordance with the movement of the vehicle 1, the cameras CAM used for calculating the vehicle position are switched. By switching the cameras CAM, even when the vehicle 1 moves and becomes not included in the capturing range of one camera CAM, the vehicle 1 can become included in the capturing range of the next camera CAM.

The timing of switching the cameras CAM capturing the video VID is considered. A switching condition for switching the cameras CAM is set in each of the first position estimation unit 111 and the second position estimation unit 113. Examples of the switching condition include the following. The first example is that the difference between the installation position of the camera CAM currently capturing the image of the vehicle 1 and the position of the vehicle 1 exceeds a threshold value. The second example is that the vehicle 1 passes through a predetermined position within the angle of view of the camera CAM currently being used. The third example is that the front end of the vehicle 1 passes through a predetermined position in the angle of view of the camera CAM to be used next.

Since the algorithm applied to the first position estimation unit 111 is different from the algorithm applied to the second position estimation unit 113, the switching condition of cameras may be different. For example, when the switching condition is that the difference between the installation position of the camera CAM and the position of the vehicle 1 exceeds a threshold value, threshold values set as the switching conditions may be different. As another example, when the switching condition is that the vehicle 1 passes through a predetermined position within the angle of view of the camera CAM currently used, predetermined positions set as the switching conditions may be different. When the switching conditions are different, a period may occur in which the camera CAM used for calculating the first vehicle position PV1 and the camera CAM used for calculating the second vehicle position PV2 do not coincide with each other. When the first vehicle position PV1 and the second vehicle position PV2 are calculated based on the different cameras CAM, the position difference ΔPV may be increased. The deviation state detected due to such a factor is not caused by abnormality in the position estimation process itself but is simply caused by the fact that the cameras CAM to be used do not coincide. In other words, when the cameras CAM are switched at different timing in the first position estimation unit 111 and the second position estimation unit 113, the deviation state may be erroneously detected although the position estimation processes themselves are normal.

Therefore, the vehicle control system 100 aligns the timing of switching the cameras CAM between the first position estimation unit 111 and the second position estimation unit 113. That is, the camera CAM1 is switched to the camera CAM2 such that the camera CAM used by the first position estimation unit 111 to calculate the first vehicle position PV1 and the camera CAM used by the second position estimation unit 113 to calculate the second vehicle position PV2 coincide with each other.

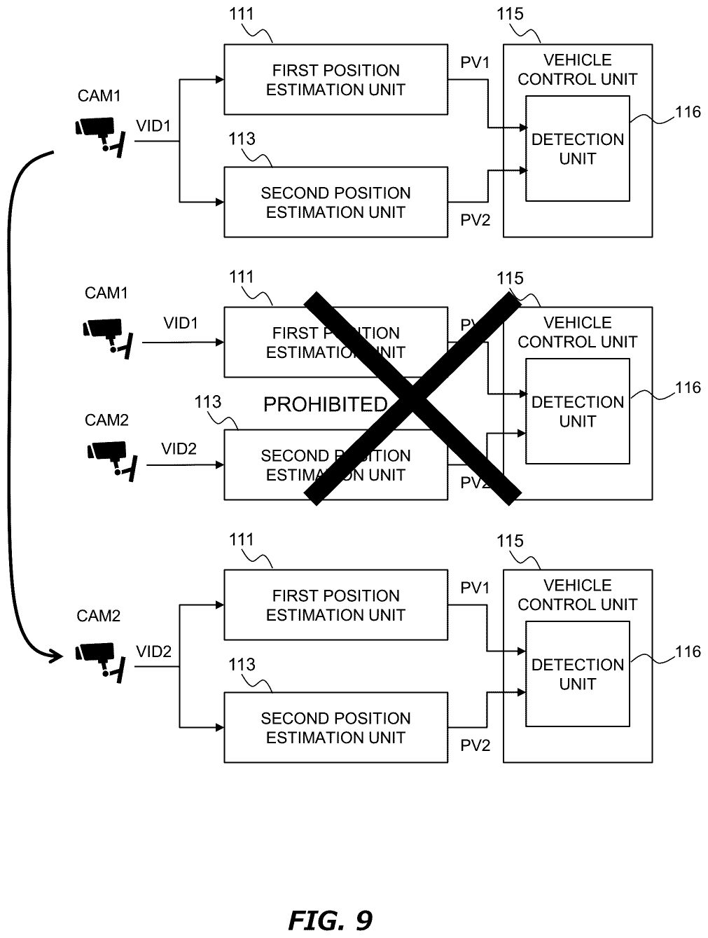

FIG. 9 shows an example of switching of the cameras CAM performed such that the camera CAM used by the first position estimation unit 111 to calculate the first vehicle position PV1 and the camera CAM used by the second position estimation unit 113 to calculate the second vehicle position PV2 coincide with each other. The vehicle control system 100 determines whether a first condition and a second condition are satisfied or not. Then, the vehicle control system 100 switches the camera CAM used for calculating the first vehicle position PV1 and the second vehicle position PV2 after both the first condition and the second condition are satisfied. The first condition is a condition for allowing the camera CAM used for calculating the first vehicle position PV1 by the first position estimation unit 111 to be switched. The second condition is a condition for allowing the camera CAM used for calculating the second vehicle position PV2 by the second position estimation unit 113 to be switched.

The first condition and the second condition are, for example, the same conditions as the switching conditions described above. Since the first condition and the second condition are different, there is a possibility that either one of them is satisfied first, but even if only one of them is satisfied previously, the camera CAM is not previously switched in only one of the position estimation units.

In a situation shown at the top of FIG. 9, neither the first condition nor the second condition is satisfied, and thus both the first position estimation unit 111 and the second position estimation unit 113 acquire the video VID from the camera CAM1. Then, only the second condition is satisfied. At this time, since the first condition is not satisfied, the cameras CAM are not switched in the second position estimation unit 113 and the camera CAM1 is continuously used. Then, when the first condition is further satisfied, the camera CAM1 is switched to the camera CAM2 in both the first position estimation unit 111 and the second position estimation unit 113.

By aligning the switching timing of the camera CAM like this, the following effects can be obtained. The cameras CAM used by the first position estimation unit 111 and the camera CAM used by the second position estimation unit 113 coincide. That is, the first vehicle position PV1 and the second vehicle position PV2 are prevented from unnecessarily deviating from each other due to the fact that the cameras CAM do not coincide. This prevents the state from being erroneously determined as the deviation state even though the position estimation process itself is normal. As a result, unnecessary deceleration is restrained, and sense of discomfort of the occupant is also suppressed.

### 6. Sixth Embodiment

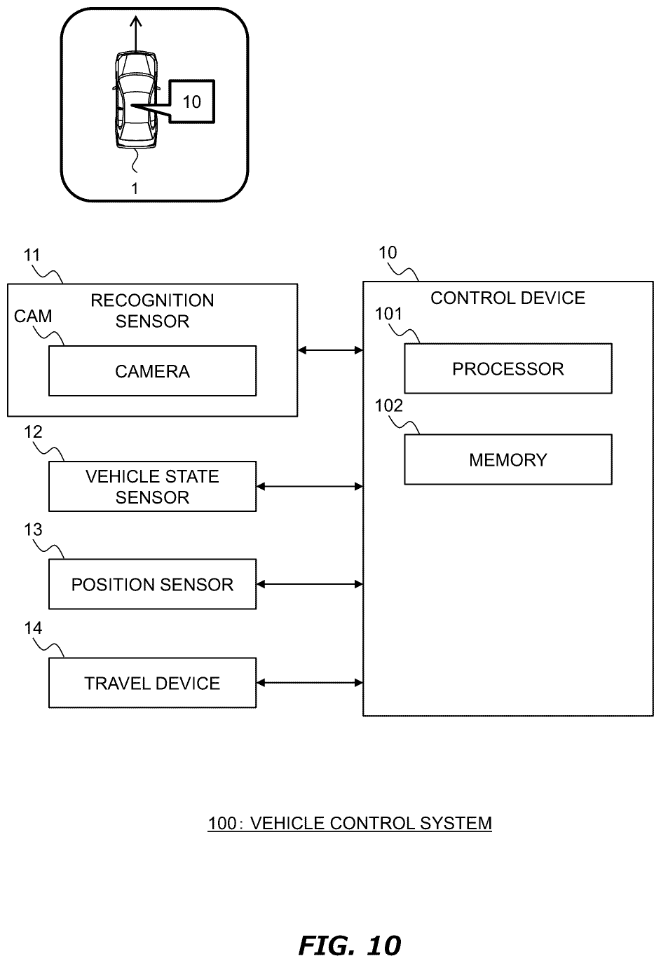

FIG. 10 is a block diagram showing a configuration example of the vehicle 1 in the sixth embodiment. In the sixth embodiment, the camera CAM is an in-vehicle camera mounted on the vehicle 1. The vehicle control system 100 includes a control device 10 mounted on the vehicle 1. The vehicle control system 100 may further include a recognition sensor 11, which recognizes the surroundings of the vehicle 1, a vehicle state sensor 12, which detects a state of the vehicle 1, a position sensor 13, which detects the position of the vehicle 1, and a travel device 14.

The control device 10 includes the processor 101 and the memory 102. The control device 10 may be a part of an autonomous driving system of the vehicle 1. That is, at least a part of the processor 101 and the memory 102 may be common to a processor and a memory constituting the autonomous driving system of the vehicle 1. The processor 101 may be, for example, one or a plurality of electronic control units (ECUs).

In this case, the position estimation by one or both of the first position estimation unit 111 and the second position estimation unit 113 may be localization, in which the self-position is estimated by combining the recognition result based on the video VID from the camera CAM and the map information.

As another example, when the camera CAM is an in-vehicle camera, the processor 101 and the memory 102 may also be included in the server outside the vehicle 1. Alternatively, a part of the processor 101 and the memory 102 may be included in the outside server, and the processing by the vehicle control system 100 may be performed dispersively by the vehicle 1 and the outside server.

The first to sixth embodiments is described above. Of these, the fifth embodiment is limited to a case where the camera CAM is an infrastructure camera and cannot be combined with the sixth embodiment. However, two or more of the other embodiments can be arbitrarily combined.

What is claimed is:

1. A vehicle control system for controlling a vehicle, comprising processing circuitry configured to:
acquire a video captured by a common camera;
calculate a first vehicle position that is a position of the vehicle from the video based on a first position estimation algorithm;
calculate a second vehicle position that is a position of the vehicle from the video based on a second position estimation algorithm; and
decelerate or stop the vehicle according to a deviation state in which a position difference between the first vehicle position and the second vehicle position exceeds an allowable error.

2. The vehicle control system according to claim 1, wherein
an environment parameter is a width of a lane in which the vehicle is present or a distance between the vehicle and an obstacle around the vehicle, and
the processing circuitry is further configured to increase the allowable error as the environment parameter increases.

3. The vehicle control system according to claim 1, wherein the processing circuitry is further configured to decelerate the vehicle when the deviation state is detected or when detection of the deviation state continues for a predetermined period.

4. The vehicle control system according to claim 1, wherein the processing circuitry is further configured to:
start deceleration of the vehicle when the deviation state is detected;
stop the vehicle when detection of the deviation state continues for a predetermined period; and
cancel the deceleration of the vehicle when the detection of the deviation state is resolved before continuing for the predetermined period.

5. The vehicle control system according to claim 1, wherein the processing circuitry is further configured to:
stop the vehicle when the deviation state is detected;
notify an administrator of the vehicle or switch the vehicle to remote driving when detection of the deviation state continues for a predetermined period; and
cancel stopping the vehicle when the detection of the deviation state is resolved before continuing for the predetermined period.

6. The vehicle control system according to claim 1, wherein the processing circuitry is further configured to:
stop the vehicle when a calculation impossible state in which either the first vehicle position or the second vehicle position cannot be calculated is detected; and
cancel stopping the vehicle when the calculation impossible state is resolved before continuing for a predetermined period.

7. The vehicle control system according to claim 1, wherein
a first image is an image included in the video and used for calculating the first vehicle position,
a second image is an image included in the video and used for calculating the second vehicle position, and
the processing circuitry is further configured to increase the allowable error as a time difference between the first image and the second image becomes larger.

8. The vehicle control system according to claim 7, wherein
the first image is an image used for calculating a latest first vehicle position,
the second image is an image used for calculating a latest second vehicle position, and
the processing circuitry is further configured to calculate a difference between the latest first vehicle position and the latest second vehicle position as the position difference.

9. The vehicle control system according to claim 7, wherein the processing circuitry is further configured to:
store information about the first vehicle position and information about the second vehicle position in a buffer; and
calculate the position difference between the first vehicle position and the second vehicle position based on the first vehicle position and the second vehicle position where the time difference between the first image and the second image is less than an allowable time difference.

10. The vehicle control system according to claim 1, wherein
the common camera is an infrastructure camera outside the vehicle, and
the vehicle is shown in the video.

11. The vehicle control system according to claim 10, wherein
the common camera includes a first common infrastructure camera and a second common infrastructure camera installed at a position where the second common infrastructure camera captures the vehicle after the first common infrastructure camera, and
the processing circuitry is further configured to switch the common camera from the first common infrastructure camera to the second common infrastructure camera such that the common camera used for calculating the first vehicle position and the common camera used for calculating the second vehicle position coincide with each other.

12. The vehicle control system according to claim 11, wherein the processing circuitry is further configured to:
allow the common camera used for calculating the first vehicle position to be switched from the first common infrastructure camera to the second common infrastructure camera when a first condition is satisfied;
allow the common camera used for calculating the second vehicle position to be switched from the first common infrastructure camera to the second common infrastructure camera when a second condition is satisfied;
use the first common infrastructure camera for calculating the first vehicle position and calculating the second vehicle position until both the first condition and the second condition are satisfied; and
switch the common camera used for calculating the first vehicle position and calculating the second vehicle position from the first common infrastructure camera to the second common infrastructure camera after both the first condition and the second condition are satisfied.

13. A vehicle control method for controlling a vehicle, comprising:
acquiring a video captured by a common camera;
calculating a first vehicle position that is a position of the vehicle from the video based on a first position estimation algorithm;
calculating a second vehicle position that is a position of the vehicle from the video based on a second position estimation algorithm; and
decelerating or stopping the vehicle according to a deviation state in which a position difference between the first vehicle position and the second vehicle position exceeds an allowable error.
